(19) United States
(12) Patent Application Publication
(10) Pub. No.: US 2026/0257627 A1
(43) Pub. Date: Sep. 3, 2026

(54) TRUCK BED MAT

(71) Applicant: LEGEND FLEET SOLUTIONS, Tillsonburg (CA)

(72) Inventors: Yorke Graham, Tillsonburg (CA); Ross Graham, Tillsonburg (CA)

(21) Appl. No.: 19/554,397

(22) Filed: Mar. 2, 2026

Related U.S. Application Data
(60) Provisional application No. 63/766,304, filed on Mar. 3, 2025.

(51) Int. Cl. B60R 13/01

(52) U.S. Cl. CPC B60R 13/01

(57) ABSTRACT

A truck bed mat assembly for protecting the bed of a truck having a frame with a front member, a back member, and opposed side members interconnecting the front member and back member. The front, back, and side members each have a top surface and a bottom surface, with the bottom surface spaced from the top surface so that the top surface is raised relative to the bottom surface. Each side member has opposed longitudinally extending edges with the mounting flanges extending from each of the opposed longitudinally extending edges. The front member and back members are connected to the mounting flanges. A rigid mat material is mounted to the mounting flanges. Mounting brackets extend from each front and back member, with each mounting bracket having a base and a body portion. The base is connected to one of the front or back members, and the body portion has an opening for receiving a D-ring to connect the truck bed mat assembly to the truck bed.

### CROSS-REFERENCE TO RELATED APPLICATIONS

This application claims the benefit of U.S. Provisional Application No. 63/766,304 filed on Mar. 3, 2025, which is incorporated herein by reference in its entirety.

### TECHNICAL FIELD

This invention generally relates to a truck bed mat and, more particularly, to a comprehensive cargo-management truck bed floor mat designed to protect the truck's bed, the overall value of the vehicle, and to provide a tie-down system and storage surface. The mat is installed without drilling into the truck body.

### BACKGROUND OF THE INVENTION

Truck beds see the most abuse of any part of the truck. They are often made from thin-gauge aluminum or metal, leaving them vulnerable to damage.

Trucks are widely used to transport tools, equipment, building materials, recreational gear, and other cargo. During routine loading, unloading, and transport, the truck bed is exposed to abrasion, sliding impacts, point loads, chemical spills, moisture, and environmental exposure. These conditions can mar painted or coated bed surfaces, create dents and scratches, contribute to corrosion, and reduce resale value. As a result, many different products and approaches have been developed to protect truck beds.

One common approach is a spray-applied protective coating (often referred to as a “spray-in” bedliner). In general, these coatings are applied directly onto the bed floor and sidewalls to form a continuous layer that conforms to contours, corners, and features of the bed. Spray-on liners are typically promoted as creating a durable barrier that bonds to the underlying surface and provides an integrated, seamless coating. This solution can reduce scratches and abrasions, but does not add structural integrity. As a result, truck beds remain vulnerable to dents and tears from everyday use.

Another approach is the use of pre-formed rigid liners, often called drop-in bedliners. These products are commonly formed from polymeric sheet materials (e.g., high density polyethylene) and installed as a shaped insert within the bed. Drop-in liners can provide substantial protection against dents and dings from heavy loads. However, these can leave gaps between the liner and the bed that can permit debris and moisture accumulation, and movement or vibration of the liner can lead to rubbing or wear at contact points.

Still other products provide a carpeted or cushioned bed covering, sometimes using polymer fibers and a foam backing to create a softer surface that is easier on a user's knees while loading or accessing cargo. These systems may be configured as cut-to-fit mats or vehicle-specific kits and maybe designed for cleaning with a hose or pressure washer. Some products combine materials for example, a more rugged mat on the floor and softer side panels to balance comfort and durability.

Despite the availability of these different options, truck owners may still encounter practical issues such as: achieving reliable non-slip performance for varying cargo types; maintaining drainage and cleaning, and avoiding trapped moisture or debris; resisting curling, warping, cracking, or excessive wear over time; and providing adequate coverage and protection while remaining easy to install, remove, and service.

The present invention provides a comprehensive cargo management truck bed floor designed to protect the truck's value and enhance its practical application.

### SUMMARY OF THE INVENTION

In general terms, this invention provides a truck bed liner that solves the problems of known liners and mats. It is made from a thick rigid material and more than doubles the durability of a bed and prevents costly damage to the truck. The rigid material is non-slip to better secure cargo and is soft to provide comfort to a user. Inlaid longitudinally extending metal rails provide flexible tie-down points for a variety of potential cargo. The tie-down points also provide drainage for the bed. The system also requires no drilling for installation. The truck bed floor uses factory-mount points for a smooth, simple install. Four mounting brackets secure the floor to the bed and act as additional tie-down points.

A truck bed mat assembly has a frame with a front member, a back member, and opposed side members that interconnect the front and back members. The front, back, and side members each have a top surface and a bottom surface, with the bottom surface spaced from the top surface so that the top surface is raised relative to the bottom surface. Each side member has opposed longitudinally extending edges with the mounting flanges extending from each of the opposed longitudinally extending edges. The front member and back members are connected to the mounting flanges. A rigid mat material is mounted to the mounting flanges. Mounting brackets extend from each front and back member, with each mounting bracket having a base and a body portion. The base is connected to one of the front or back members, and the body portion has an opening for receiving a D-ring to connect the truck bed mat assembly to the truck bed.

These and other features and advantages of this invention will become more apparent to those skilled in the art from the detailed description of a preferred embodiment. The drawings that accompany the detailed description are described below.

### BRIEF DESCRIPTION OF THE DRAWINGS

FIG. 1 is a top-perspective view of a truck bed with the truck bed mat of the present invention mounted within the truck bed.

FIG. 2 is a perspective exploded view of the support frame.

FIG. 3 is a bottom perspective view of the support frame members.

FIG. 4 is a top exploded view of the truck bed mat.

FIG. 5 is a front perspective view of the mounting bracket.

FIG. 6 is a rear perspective view of the mounting bracket.

### DETAILED DESCRIPTION OF A PREFERRED EMBODIMENT

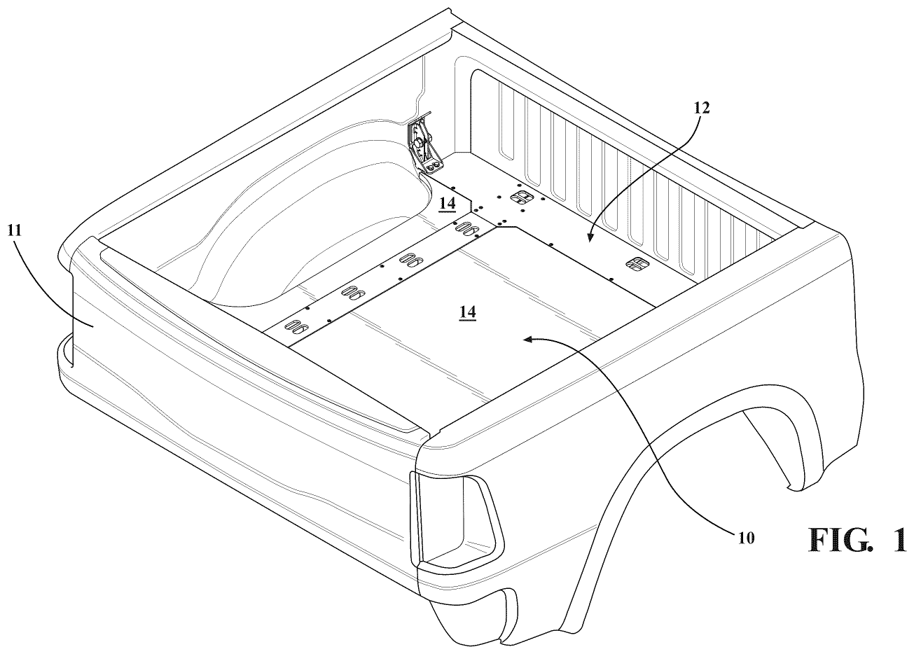

With reference to FIG. 1, the truck bed mat of the present invention is shown generally at 10 installed in the bed of a pickup truck 11. The truck bed mat 10, as shown in the figures, includes a support frame 12 and a thick, rigid mat material 14. The liner 14 can be made of rubber or similar materials typically used for truck beds. In the disclosed embodiment, the material is 19 mm polyurethane core embedded with fiberglass and a TPE top skin.

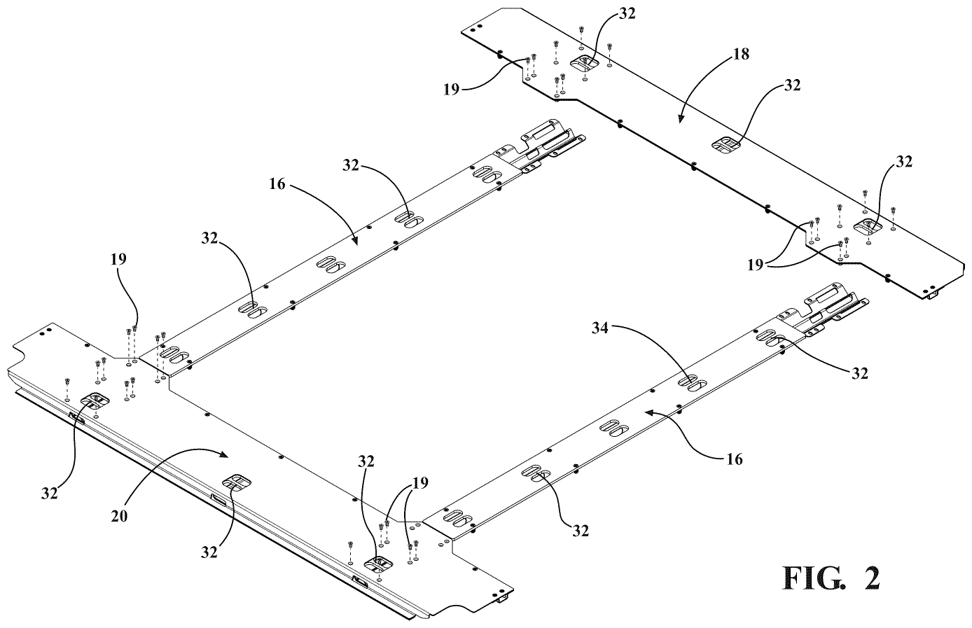

With reference to FIG. 2, the support frame 12 has side weldments 16, a front weldment 18, and a rear weldment 20. The weldments as disclosed are made of metal and, more particularly, aluminum. The side weldments 16 are bolted to the front weldment 18, and the rear weldment 20 to create the support frame 12. In the disclosed embodiment, M6×1 long flush head stainless steel studs are used with washers and hex lock nuts, shown generally at 19. It will be understood that other connection methods could be used, such as interlocking tabs, metal stitching, or welding.

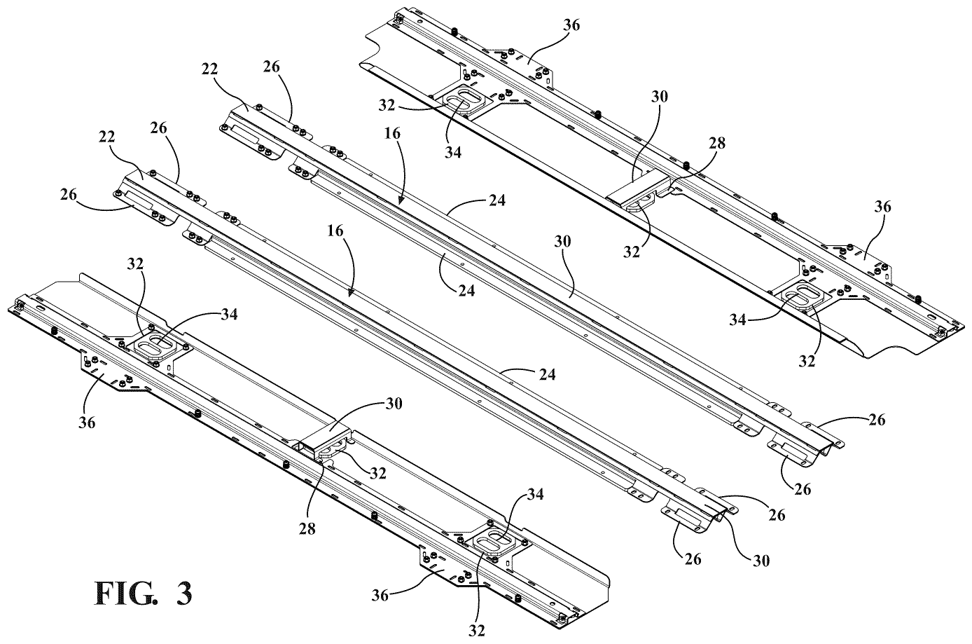

With reference to FIG. 3, the side weldments 16 have a longitudinally extending base 22 with body flanges 24 extending from each longitudinal side of the base 22 and end flanges 26. These have holes 26 for mounting. The front weldment 18 and rear weldment 20 have a raised transverse support 28. The base 22 and supports 28 rest upon the truck bed and support the mat in the truck bed 11. To prevent marring of the truck bed 11, foam pads 30 are secured to the base 22 and supports 28.

Tie-down openings 32 are provided along the length of the side weldments 16, the front weldment 18, and the rear weldment 20. The tie-down openings have a crossbar 34 for the tie-downs. The base 22 and support 28 provide a space for the tie-down openings 32 to accept tie-downs.

The front weldment 18 and rear weldment 20 have attachment flanges 36 for mounting to the end flanges 26 of the side flanges 16.

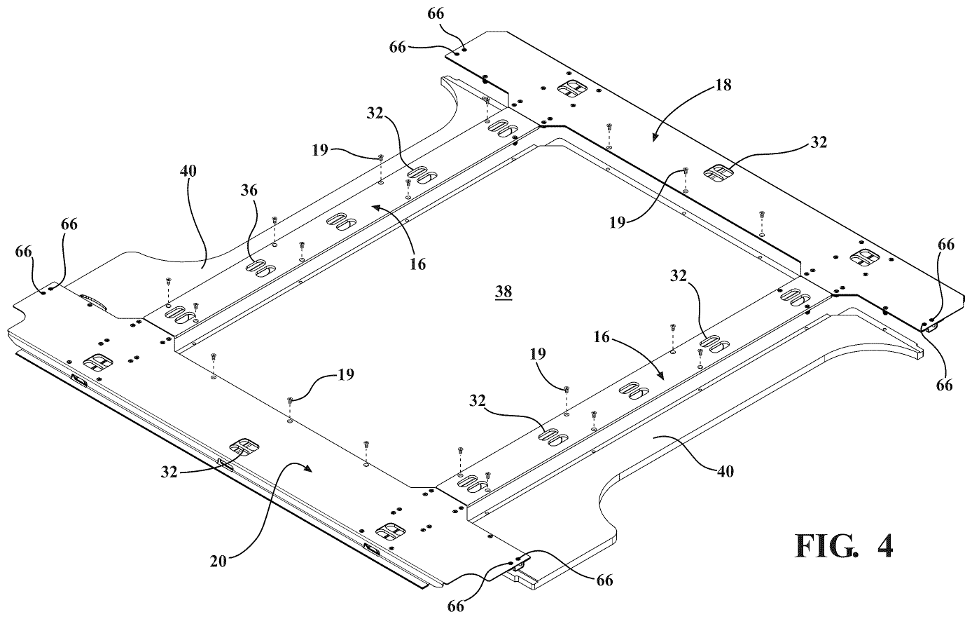

With reference to FIG. 4, the rigid mat material 14 has three sections: the body portion 38 and two side portions 40. Body portion 38 is bolted to the inside of the side weldments 16, front weldment 18 and rear weldment 20. The two side sections 40 are each bolted to the outside of side weldments 16. In the disclosed embodiment, M6×1 long flush head stainless steel studs are used with washers and hex lock nuts, shown generally at 19. As disclosed, the two side portions 40 are contoured to receive the wheel well in the pickup truck bed.

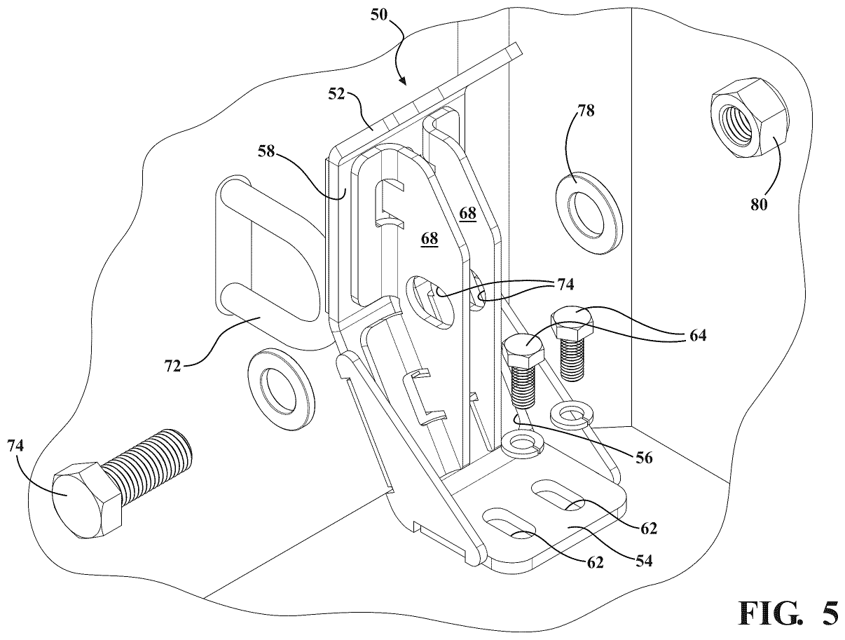

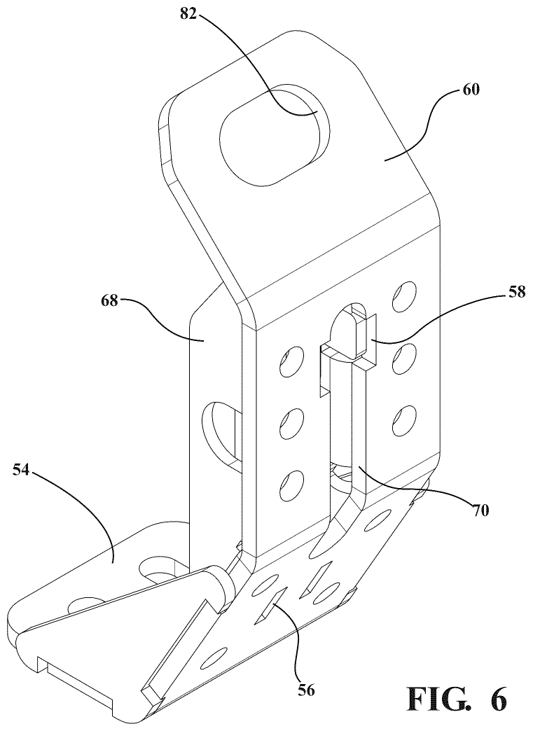

With reference to FIGS. 5 and 6, the mounting brackets are shown generally at 50. Each mounting bracket has an angled body 52. The body 52 includes a base 54, a back member 56, a top member 58, and a top tiedown 60. Brace members 61 are provided for added strength. The base 54 has two oblong mounting holes 62 for the receipt of mounting bolts 64. The mounting bolts 64 extend through the oblong mounting holes 62 and through the mounting holes 66 on the sides of the front weldment 18 and rear weldments 20. In the disclosed embodiment, the mounting bolts 64 are M8×16 mm hex head bolts and M8 washers. The mounting holes 66 are threaded to receive the mounting bolts 64. Instead of threaded mounting holes 66, nuts could be used.

D-ring mounting ears 68 are mounted to the back member 56 and the top member 58. The back member 56 and the top member 58 have a slot 70 for receiving the D-ring 72. Each ear 68 has an oblong slot 74 for receipt of a D-ring mounting bolt 76. The D-ring mounting bolt 76 of the disclosed embodiment is a M16×40 hex head bolt and has a M16 washer 78 and M16 lock nut 80.

The top tiedown 60 has an opening 82 for the receipt of a tie-down. Foam pads 30 can be mounted to the rear of the mounting brackets to prevent marring.

In use, the truck bed mat 10 is preferably assembled and then placed into the truck bed. Once positioned in the truck bed, the D-rings 72 are inserted into the slots 74 in the mounting brackets 50, and the bolt 76 locks them together, securing the mat 10 in the bed 11. The mat 10 is installed without drilling any holes in the bed 11 and with commonly available hand tools.

The foregoing invention has been described in accordance with the relevant legal standards, thus the description is exemplary rather than limiting in nature. Variations and modifications to the disclosed embodiment may become apparent to those skilled in the art and do come within the scope of the invention. Accordingly, the scope of legal protection afforded this invention can only be determined by studying the following claims.

What is claimed is:

1. A truck bed mat assembly for protecting the bed of a truck comprising:
a frame having a front member, a back member, and opposed side members interconnecting said front member and back member;
said front, back, and side members each having a top surface and bottom surface, with said bottom surface being spaced from said top surface such that said top surface is raised with respect to said bottom surface;
said side members having opposed longitudinally extending edges;
mounting flanges extending from each of said opposed longitudinally extending edges, said front member and back member being connected to said mounting flanges;
a rigid mat material mounted to said to said mounting flanges;
mounting brackets extending from each of said front and back members, each of said mounting brackets having a base and body portion, said base is connected to one of said front or back members, said body portion having an opening for receipt of a D ring for connecting said truck bed assembly to a truck bed.

2. The truck bed mat assembly of claim 1, wherein said front, back, and side members have spaced openings for securing cargo to said truck bed mat.

3. The truck bed mat assembly of claim 2, wherein said spaced openings extend through said top surface and have cross-bars extending across said openings for receipt of tie-downs.

4. The truck bed mat assembly of claim 1, wherein said rigid mat material includes three separate sections, a main section, a first side section, and a second side section, said main section is mounted to front, back and side members, said first side section is mounted to one of said side members and said second section is mounted to said other side member.

5. The truck bed mat assembly of claim 1, wherein said first and second side sections each have a recessed area.

6. The truck bed mat assembly of claim 1, wherein said rigid mat material is flush with said top surface of said front, back, and opposed side members.

7. The truck bed mat assembly of claim 1, wherein said rigid mat material is a polyurethane core embedded with fiberglass and a TPE top skin.

8. The truck bed mat assembly of claim 1, wherein said mounting brackets include a tie-down.

9. The truck bed mat assembly of claim 1, further including a fastener extending through said opening and said D ring for connecting said truck bed assembly to a truck bed.

10. A truck bed mat assembly for protecting the bed of a truck comprising:
a frame having a top surface and bottom surface, with said bottom surface being spaced from said top surface such that said top surface is raised with respect to said bottom surface to create a space for drainage;
mounting flanges extending from said frame;
a rigid mat material mounted to said mounting flanges;
mounting brackets mounted to said frame, said mounting brackets each having a base portion and a body portion, said body portion having an opening for receipt of a D ring;
a fastener extending through said opening and said D ring for connecting said truck bed assembly to a truck bed.

11. The truck bed mat assembly of claim 9, wherein said frame has a front member, a back member, and opposed side members interconnecting said front member and back members.

12. The truck bed mat assembly of claim 1, wherein said front, back, and side members have spaced openings for securing cargo to said truck bed mat.

13. The truck bed mat assembly of claim 2, wherein said spaced openings extend through said top surface and have cross-bars extending across said openings for receipt of tie-downs.

14. The truck bed mat assembly of claim 1, wherein said rigid mat material includes three separate sections, a main section, a first side section, and a second side section, said main section is mounted to front, back and side members, said first side section is mounted to one of said side members and said second section is mounted to said other side member.

15. The truck bed mat assembly of claim 1, wherein said first and second side sections each have a recessed area.

16. The truck bed mat assembly of claim 1, wherein said rigid mat material is flush with said top surface of said frame.

17. The truck bed mat assembly of claim 1, wherein said rigid mat material is a polyurethane core embedded with fiberglass and a TPE top skin.

18. The truck bed mat assembly of claim 1, wherein said mounting brackets include a tie-down.
